(19) United States
(12) Patent Application Publication
(10) Pub. No.: US 2012/0088136 A1
(43) Pub. Date: Apr. 12, 2012

(54) NON-AQUEOUS ELECTROLYTE SECONDARY BATTERY

(76) Inventors: Yasutaka KOGETSU, Osaka (JP); Hitoshi Katayama, Osaka (JP)

(21) Appl. No.: 13/232,562

(22) Filed: Sep. 14, 2011

(30) Foreign Application Priority Data
Oct. 12, 2010 (JP) 2010-230063

(51) Int. Cl. H01M 4/13

(52) U.S. Cl. 429/94

(57) ABSTRACT

Disclosed is a non-aqueous electrolyte secondary battery including: a cylindrical wound electrode group including a belt-like negative electrode, a belt-like positive electrode, and a belt-like separator interposed therebetween, the electrodes and separator being laminated and wound together; and a non-aqueous electrolyte. The cross section perpendicular to the winding axis of the electrode group has a radius of 3 mm or more. The negative electrode includes a current collector, an active material layer including a silicon-based active material and adhering to the surface of the current collector, and a strip-like lead connected to the current collector via an alloy layer comprising a copper-silicon alloy. The lead is connected at the round of winding radially 3 mm or more away from the winding axis of the electrode group, and includes a copper foil or copper alloy foil having a tensile strength per unit length of the short side width thereof of 3 N/mm to 50 N/mm.

### FIELD OF THE INVENTION

The invention relates to non-aqueous electrolyte secondary batteries. Specifically, the invention relates to an improved connection between the negative electrode and the negative electrode lead in non-aqueous electrolyte secondary batteries including a silicon-based negative electrode active material.

### BACKGROUND OF THE INVENTION

Non-aqueous electrolyte secondary batteries including an alloy-forming active material that absorbs lithium by being alloyed with lithium, such as a silicon-based active material, (hereinafter referred to as “alloy-type secondary batteries”) are known. Alloy-type secondary batteries have higher capacities and higher energy densities than conventional non-aqueous electrolyte secondary batteries including graphite as a negative electrode active material. Therefore, alloy-type secondary batteries are expected not only as power sources for electronic equipment, but also as main power sources or auxiliary power sources for transportation equipment or machining equipment.

The conventional negative electrode includes, for example, a current collector such as a copper foil, and an active material layer containing a binder and an active material such as graphite formed on the surface of the current collector. To the end portion of the current collector, a lead serving as an output/input terminal is spot-welded at several points. Specifically, on the surface of the current collector, a portion to which a lead is to be welded is left uncoated with the active material layer, and the current collector is exposed at this portion. The lead is directly welded to this exposed portion.

FIG. 11 is a plane view schematically showing how a lead is conventionally connected to an electrode 100 by spot welding. In the electrode 100, at the portion where a current collector 101 is exposed, the electrode 100 and a lead 103 are arranged such that the longitudinal directions of the electrode 100 and the lead 103 orthogonally cross each other, and one end of the electrode 100 in the width direction thereof overlaps one end of the lead 103 in the longitudinal direction thereof. These are welded at two or more welding points 104 by spot welding.

A known example of the negative electrode for use in alloy-type secondary batteries is a silicon-based negative electrode formed by allowing a silicon-based active material to adhere to the surface of a current collector such as a copper foil by, for example, vacuum vapor deposition, instead of forming an active material layer containing a binder. However, in producing such a silicon-based negative electrode, connecting a lead to the current collector requires a complicated operation. Specifically, in order to form a current collector-exposed portion for connecting a lead thereto as in the conventional negative electrode, for example, a predetermined area needs to be masked to secure the portion for connecting a lead thereto, prior to vacuum vapor deposition, so that no silicon-based active material will be vapor-deposited on this area. Such masking operation complicates the process.

In order to solve this problem, the present inventors have proposed a method of connecting, by arc welding, a lead including at least one selected from the group consisting of nickel, a nickel alloy, copper, and a copper alloy, to a current collector with active material layers comprising a silicon-based active material provided on both surfaces thereof (see Patent Document 1). Specifically, a lead is placed in an overlapping manner on the active material layer formed on the current collector, and arc welding is applied to the overlapping portion, thereby to form a silicon-based alloy layer between the current collector and the lead, which allows the current collector and the lead to be connected to each other with good electrical conductivity therebetween. Such a silicon-based alloy layer is formed when the active material layer melts together with part of the current collector and part of the lead, and then solidifies again.

FIG. 12 is a plane view schematically showing how a lead 117 is connected to a silicon-based negative electrode 10 by arc welding. By arc welding the lead 117 to the silicon-based negative electrode 10, the lead 117 is connected to the current collector of the silicon-based negative electrode 10 via an alloy layer 120. Since connection is achieved without the necessity of forming an exposed portion of the current collector, by placing the lead in an overlapping manner on the silicon-based active material layer formed on the current collector and applying arc welding to the overlapping portion, this technique is advantageous industrially.

Patent Document 2, which relates to a lead, intends to reduce the thickness and weight of a lead, and discloses a lead in which a welding layer comprising nickel, a nickel alloy, or an iron alloy is laminated on a base layer comprising copper or a heat-resistant copper alloy.

Patent Document 3 discloses a technique to prevent disconnection of the lead from the electrode terminal in a thin battery to be used as a driving power source for electric vehicles, by using a flat electrode terminal provided with bending lines.

Patent Document 1: International publication No. WO 2010/041399

Patent Document 2: Japanese Laid-Open Patent Publication No. Hei. 11-297300

Patent Document 3: Japanese Laid-Open Patent Publication No. 2007-73485

### BRIEF SUMMARY OF THE INVENTION

The technique disclosed in Patent Document 1 apparently eases the welding of a lead to a silicon-based negative electrode. However, the present inventors have found such technique still be susceptible to improvement as described below.

In the silicon-based negative electrode, an alloy layer which is high in mechanical strength but is brittle is formed between the current collector and the lead by arc welding. In forming a wound electrode group, the lead is curved according to the curvature of the electrode group. However, in the case of using the silicon-based negative electrode to which the lead is arc-welded, because of the brittleness of the alloy layer, the more the portion at which the lead is connected is curved, the more likely the lead is partially separated from the silicon-based negative electrode or broken.

The invention intends to provide a non-aqueous electrolyte secondary battery including a wound electrode group including a silicon-based negative electrode to which a lead is connected via an alloy layer including a copper-silicon alloy, in which the occurrence of partial separation from the silicon-based negative electrode and breakage of the lead is suppressed.

A non-aqueous electrolyte secondary battery of the invention includes: a wound electrode group including a belt-like positive electrode, a belt-like negative electrode, and a belt-like separator interposed between the positive electrode and the negative electrode, the positive electrode, the negative electrode, and the separator being laminated and wound together; and a non-aqueous electrolyte. The negative electrode includes a current collector, an active material layer containing a silicon-based active material adhering to the surface of the current collector, a strip-like lead connected to the current collector via an alloy layer comprising a copper-silicon alloy. The lead includes a copper foil or a copper alloy foil having a tensile strength per unit length of the short side width thereof of 3 N/mm to 50 N/mm.

In one aspect of the invention, the electrode group has a cylindrical shape, the cross section perpendicular to the winding axis of the electrode group has a radius of 3 mm or more, and the lead is connected at the round of winding radially 3 mm or more away from the winding axis (the center) of the electrode group.

By using a copper foil or copper alloy foil having a tensile strength per unit length of the short side width thereof of 3 to 50 N/mm as the material of the lead, the rigidity of the lead is reduced. This reduces the internal stress to be generated at the lead connecting portion when the lead is curved, improving the followability of the negative electrode lead and alloy layer to the curving of the electrode group. As a result, the lead is prevented from being separated partially from the silicon-based negative electrode or broken during fabrication or use. Further, by connecting the negative electrode lead at the round of winding radially 3 mm or more away from the winding axis in the wound electrode group including a silicon-based negative electrode, the negative electrode lead and the alloy-layer mainly composed of a copper-silicon alloy are prevented from being curved to a large extent.

According to the invention, in a non-aqueous electrolyte secondary battery including a wound electrode group including a silicon-based negative electrode to which a lead is connected via an alloy layer mainly composed of a copper-silicon alloy, it is possible to suppress the occurrence of partial separation from the silicon-based negative electrode and breakage of the lead during fabrication or use of the battery.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical cross-sectional view schematically showing the configuration of a non-aqueous electrolyte secondary battery according to one embodiment of the invention.

FIG. 2 is a view schematically showing a cross section of the non-aqueous electrolyte secondary battery shown in FIG. 1.

FIG. 3 is a plane view schematically showing how a lead is connected to a negative electrode by arc welding.

FIG. 4 is a series of side views for explaining how to connect the lead to the negative electrode.

FIG. 5 is a schematic view of an apparatus for forming an electrode group.

FIG. 6 is an oblique view showing a negative electrode with a lead connected thereto, the negative electrode running on the surfaces of feed rollers.

FIG. 7 is a side view schematically showing the negative electrode with the lead connected thereto, the negative electrode on the surface of one of the feed rollers.

FIG. 8 is a side perspective view schematically showing the configuration of an electron beam vacuum vapor deposition apparatus.

FIG. 9 is a side perspective view schematically showing the configuration of another electron beam vacuum vapor deposition apparatus.

FIG. 10 is a vertical cross-sectional view schematically showing the configuration of a negative electrode according to an example of the invention.

FIG. 11 is a plane view schematically showing how a lead is conventionally connected to an electrode.

FIG. 12 is a plane view schematically showing how a lead is conventionally connected to a silicon-based negative electrode by arc welding.

### DETAILED DESCRIPTION OF THE INVENTION

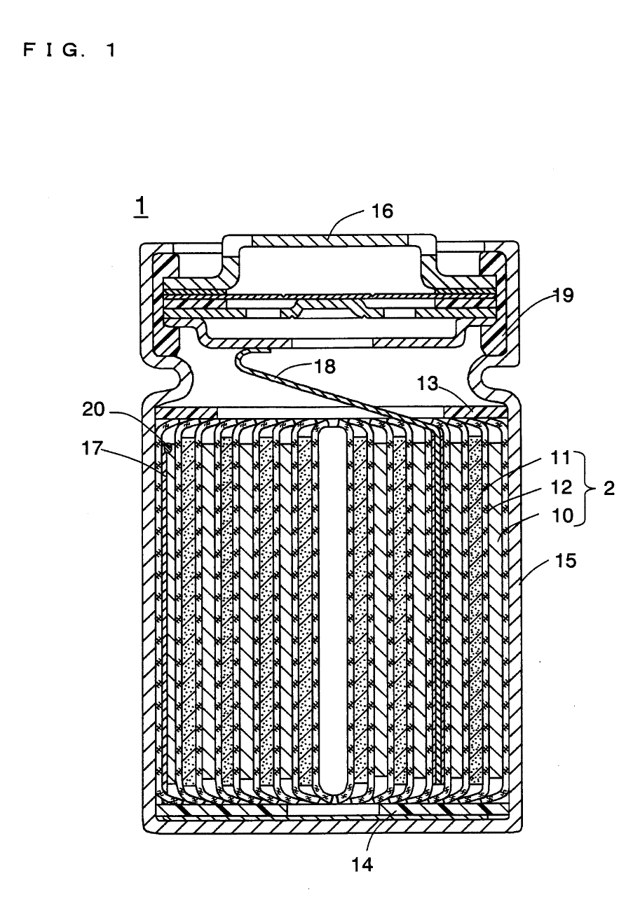

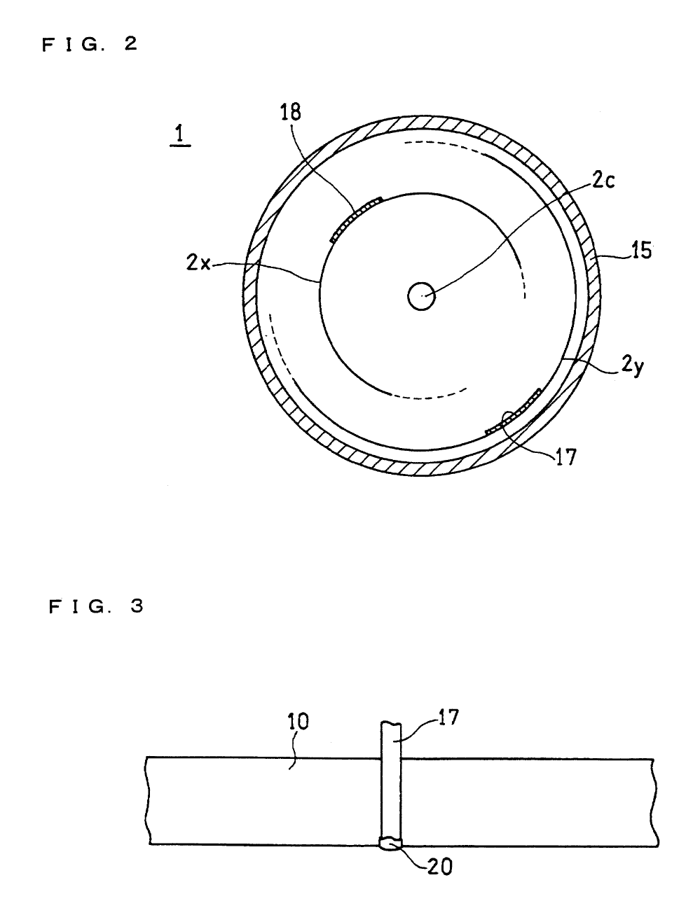

FIG. 1 is a vertical cross-sectional view schematically showing the configuration of a non-aqueous electrolyte secondary battery 1 according to one embodiment of the invention. FIG. 2 is a horizontal cross-sectional view schematically showing the configuration of the non-aqueous electrolyte secondary battery 1 shown in FIG. 1. FIG. 2 only illustrates the positions at which a negative electrode lead 17 and a positive electrode lead 18 are connected in a wound electrode group 2 of the battery 1, and the illustration of the configuration other than this is omitted. The negative electrode lead 17 is connected at a round 2y of winding near the outermost round of the electrode group 2, and the positive electrode lead 18 is connected at a round 2x of winding radially nearer the center of the electrode group 2.

The non-aqueous electrolyte secondary battery 1 is a cylindrical battery including: the wound electrode group 2 having a belt-like silicon-based negative electrode 10 (hereinafter simply referred to as a “negative electrode 10”), a belt-like positive electrode 11, and a belt-like separator 12 interposed therebetween; insulating plates 13 and 14 disposed on both ends of the electrode group 2 in the longitudinal direction thereof, respectively; a bottomed cylindrical battery can 15 accommodating the electrode group 2 and a non-aqueous electrolyte (not shown) in its interior and functioning as a negative electrode terminal; a sealing plate 16 sealing the opening of the battery can 15 and functioning as a positive electrode terminal; the negative electrode lead 17 providing electrical conduction between the negative electrode 10 and the battery can 15; the positive electrode lead 18 providing electrical conduction between the positive electrode 11 and the sealing plate 16; and a gasket 19 being interposed between the battery can 15 and the sealing plate 16 and providing electrical insulation therebetween.

The wound electrode group 2 is formed by winding a laminate of the belt-like negative electrode 10, the belt-like positive electrode 11, and the belt-like separator 12 interposed therebetween, into a cylindrical shape, and has a circular or approximately circular shape when viewed from above along the winding axis. The shape of a cross section of the electrode group perpendicular to the winding axis may be an approximate circle and does not need to be a perfect circle. The outermost round of winging of the electrode group 2 is fixed by, for example, an adhesive tape.

The electrode group 2, when viewed from above, has a radius (i.e., the radius of the circle defined by the outermost round of winding) is 3 mm or more, preferably 3 mm to 30 mm, and more preferably 5 mm to 30 mm. The radius of the electrode group 2 is a radius of the circle defined by the outermost round of winding, and is half of the diameter thereof. When the circle has some distortion, the radius of the electrode group 2 is a radius of a perfect circle having the same area as the area encircled by the outermost round of winding.

The negative electrode lead 17 has a strip shape, and is connected to the end of the long side of the negative electrode 10 by, for example, plasma arc welding as described below. An alloy layer 20 mainly composed of a copper-silicon alloy as described below is formed by the plasma arc welding between the current collector and the negative electrode lead 17. Specifically, as shown in FIG. 3, these are connected such that the longitudinal directions of the negative electrode 10 and the negative electrode lead 17 orthogonally cross each other, and one end of the negative electrode 10 along the longitudinal direction thereof almost overlaps one end of the negative electrode lead 17 along the width direction thereof.

The negative electrode lead 17 is connected at the round (2y) of winding which is 3 mm or more radially away from the winding axis (the center) of the electrode group 2, and preferably is 3 mm to 30 mm radially away therefrom. When the negative electrode lead 17 is connected at such a position, the curvature (the curve) of the wound negative electrode 10 is reduced, reducing the internal stress to be generated during fabrication or use of the battery at the portion where the lead is connected. As a result, the negative electrode lead 17 is prevented from being partially separated from the negative electrode 10 or broken during fabrication or use. Provided that an orthographic projection of the electrode group 2 when viewed from above is a perfect circle, the center of the electrode group 2 is the center of the perfect circle; and provided that the orthographic projection is not a perfect circle, the center of the electrode group 2 is the center of a perfect circle inscribed in the contour of the orthographic projection.

It should be noted that the positive electrode lead 18 is connected to the positive electrode 11 at the round (2x) of winding more inward than the round at which the negative electrode lead 17 is connected in this embodiment, but this is not a limitation, and the positive electrode lead 18 may be connected to the positive electrode 11 at almost the same round or the round of winding more outward than the round at which the negative electrode lead 17 is connected.

The negative electrode lead 17 is a strip-like copper foil or copper alloy foil having a tensile strength per 1 mm of the short side width thereof of 3 N to 50 N. The tensile strength per 1 mm of the short side width is a value determined by measuring a maximum tensile strength of the negative electrode lead 17, and dividing the measured maximum tensile strength by the short side width (mm) of the negative electrode lead 17. The maximum tensile strength is measured as follows. The negative electrode lead 17 (length: 80 mm, width: 3 mm) is pulled in the longitudinal direction thereof under predetermined conditions (tensile speed: 5 mm/sec, ambient temperature: 25° C.) by using a universal tester (available from Shimadzu Corporation), and the load at which the negative electrode lead 17 is broken is defined as the maximum tensile strength. This measurement is in accordance with JIS Z-2241.

The tensile strength per 1 mm of the short side width of the negative electrode lead 17 is 3 N/mm to 50 N/mm, and preferably 20 N/mm to 45 N/mm. When the tensile strength is below 3 N/mm, the rigidity of the negative electrode lead 17 itself is reduced, and the negative electrode lead 17 may be broken depending on the condition of use. On the other hand, when the tensile strength exceeds 50 N/mm, the followability to the curving of the electrode group 2 deteriorates, and the internal stress generated at the lead connecting portion is increased, leading to easy occurrence of partial separation or breakage.

Conventionally, a Ni-based metal foil, such as a Ni foil or a copper-coated Ni foil, having a thickness of about 100 μm has been widely used as a negative electrode lead for non-aqueous electrolyte secondary batteries. Such Ni-based metal foils have a comparatively high tensile strength of about 55 N/mm. This is because the conventional technique intends to improve the connection strength between the negative electrode current collector and the negative electrode lead by increasing the mechanical strength of the negative electrode lead. In contrast, this embodiment intends to improve the connection strength between the negative electrode 10 and the negative electrode lead 17 by decreasing the mechanical strength of the negative electrode lead 17.

Examples of the copper foil or copper alloy foil constituting the negative electrode lead 17 include a tough pitch copper foil, a zirconium-copper alloy foil, and a Corson alloy foil. By using the negative electrode lead 17 of such copper foil or copper alloy foil in the battery 1 including the negative electrode 10 including a silicon-based active material, the current collection performance is improved significantly. As a result, the high-output characteristics of the battery 1 are improved, which makes the battery 1 useful also as a power source for electric powered tools or transportation equipment that require high output.

The copper foil or copper alloy foil having a tensile strength within the predetermined range can be obtained by, for example, adjusting the thickness. For example, adjusting the thickness to 0.12 mm or less (preferably, 0.02 mm to 0.12 mm) in the case of a tough pitch copper foil, to 0.1 mm or less (preferably, 0.01 mm to 0.1 mm) in the case of a zirconium-copper alloy foil, and to 0.06 mm or less (preferably, 0.01 mm to 0.06 mm) in the case of a Corson alloy foil can provide a copper foil having a tensile strength within the predetermined range.

Alternatively, the tensile strength of the copper foil and copper alloy foil can be adjusted by annealing the foil. For example, in the case of annealing a tough pitch copper foil, the annealed tough pitch foil having a thickness of 0.33 mm or less and preferably 0.05 to 0.33 mm has a tensile strength within the predetermined range. In this case, the annealing is performed at a temperature of, for example, 180° C. to 300° C. for a duration of, for example, 30 minutes to 2 hours, in an inert gas atmosphere such as argon. As described above, by selecting the thickness, the annealing conditions, or other factors, as appropriate, a copper foil having a tensile strength within the predetermined range can be obtained.

The negative electrode lead 17 of this embodiment has preferably a short side width (a widthwise length) of 3 mm or less, and more preferably 2 mm to 3 mm. By adjusting the short side width within this range, partial separation from negative electrode 10 and breakage of the negative electrode lead 17 are more unlikely to occur.

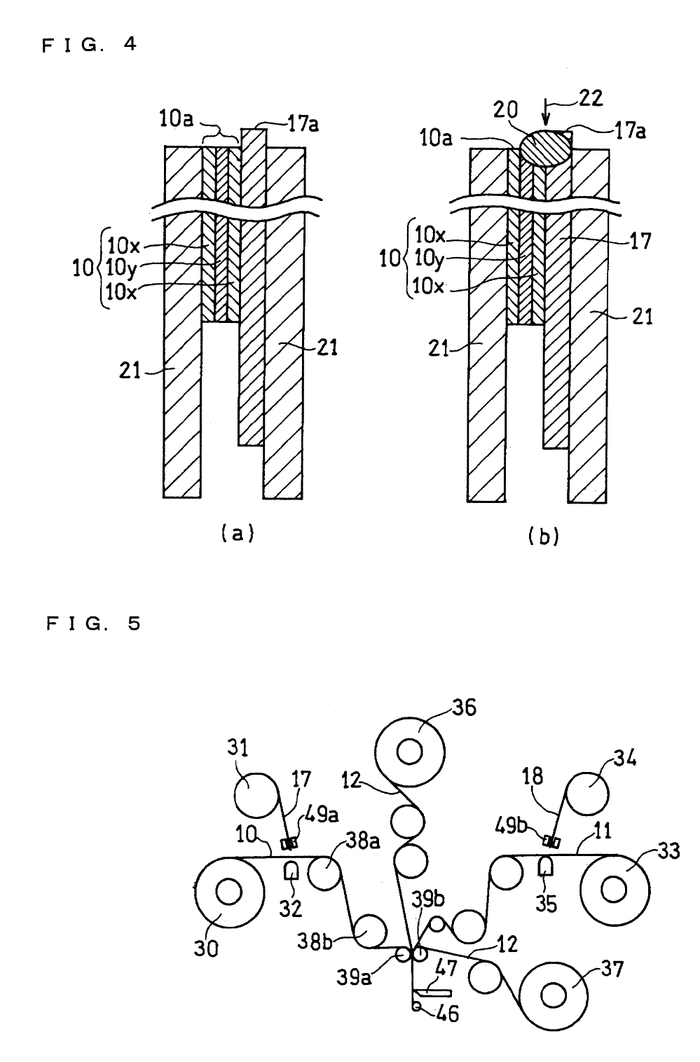

The negative electrode lead 17 can be connected to the negative electrode 10 by, for example, a method shown in FIG. 4. FIG. 4 is a series of side views for explaining how to connect the negative electrode lead 17 to the negative electrode 10. The method shown in FIG. 4 includes steps (a) and (b).

In the step (a), first, the negative electrode 10 is combined with the negative electrode lead 17 such that the longitudinal directions of the negative electrode 10 and the negative electrode lead 17 orthogonally cross each other. Then, the positions of them are adjusted such that an end surface 10a of the negative electrode 10 along the longitudinal direction thereof and an end surface 17a of the negative electrode lead 17 along the width direction thereof are oriented in the same direction, with the end surface 17a of the negative electrode lead 17 protruding by about 0.1 mm to 3 mm from the end surface 10a of the negative electrode 10. Thereafter, the negative electrode 10 and the negative electrode lead 17 are clamped by a clamping jig 21. It should be noted that the end surfaces 10a and 17a are oriented vertically upward in this embodiment, but this is not a limitation, and they may be oriented horizontally or obliquely upward.

In the step (b), while being clamped by the clamping jig 21, the negative electrode 10 and the negative electrode lead 17 are arc-welded from vertically above. Specifically, arc welding is performed by radiating energy from the welding torch of an electrode for arc welding in the direction indicated by an arrow 22 to the end surfaces 10a and 17a. This forms the alloy layer 20 mainly composed of a copper-silicon alloy at a predetermined position on the long side of the negative electrode 10, and thus the negative electrode current collector included in the negative electrode 10 and the negative electrode lead 17 are connected to each other.

A preferred arc welding is plasma welding. Plasma welding is performed by using a commercially available plasma welding machine. In performing plasma welding, the conditions therefor, such as the welding current value, the welding speed (the sweeping speed of the welding torch), the welding time, and the type of plasma gas and shielding gas and the flow rate thereof, are selected as appropriate. The welding current value is selected from the range of, for example, 1 A to 100 A. The sweeping speed of the welding torch is selected from the range of, for example, 1 mm/sec to 100 mm/sec. Examples of the plasma gas include argon gas. The flow rate of the plasma gas is selected from the range of, for example, 10 mL/min to 10 L/min. Examples of the shielding gas include argon gas and hydrogen gas. The flow rate of the shielding gas is selected from the range of, for example, 10 mL/min to 10 L/min.

The negative electrode 10 of this embodiment includes, as shown in FIG. 4, in addition to the negative electrode lead 17, a negative electrode current collector 10y and a negative electrode active material layer 10x supported on the negative electrode current collector 10y, and the alloy layer 20 connecting the negative electrode current collector 10y and the negative electrode lead 17 to each other and being mainly composed of a copper-silicon alloy.

The negative electrode current collector may be a non-porous electrically conductive base material for non-aqueous electrolyte secondary batteries. The non-porous conductive base material may be in the form of, for example, foil, sheet, or film. Among these forms, foil is preferred. The material of the conductive base material may be, for example, stainless steel, titanium, nickel, copper, or a copper alloy. Among these materials, copper or a copper alloy is preferred. Examples of the copper foil include a rolled copper foil and an electrolytic copper foil. The thickness of the conductive base material is not particularly limited, and is usually 1 μm to 500 μm, preferably 5 μm to 50 μm, and more preferably 10 μm to 30 μm.

The negative electrode active material layer is formed on both surfaces of the negative electrode current collector in the thickness direction thereof, and includes a silicon-based active material. In addition to the silicon-based active material, the negative electrode active material layer may further include, for example, a known negative electrode active material other than the silicon-based active material, and an additive, as long as such inclusion does not impair the characteristics of the negative electrode active material layer. A preferred negative electrode active material layer is an amorphous or low crystalline thin film or deposition film being composed of a silicon-based active material and having a thickness of 3 μm to 50 μm.

The silicon-based active material contains silicon, absorbs lithium by being alloyed with lithium during charge at a negative electrode potential, and releases lithium during discharge. Examples of the silicon-based active material include, without any particular limitation, silicon, a silicon compound, a partial substitution product of silicon, a partial substitution product of a silicon compound, and a solid solution of a silicon compound. Examples of the silicon compound include: a silicon oxide represented by SiOₐ, where 0.05<a<1.95; a silicon carbide represented by SiC_{b}, where 0<b<1; a silicon nitride represented by SiN_{c}, where 0<c<4/3; and a silicon alloy being an alloy of silicon and another element A. The another element A in the silicon alloy may be at least one selected from the group consisting of Fe, Co, Sb, Bi, Pb, Ni, Cu, Zn, Ge, In, Sn, and Ti.

The partial substitution product is a compound in which part of silicon in the silicon or the silicon compound is replaced with another element X. The another element X may be at least one selected from the group consisting of B, Mg, Ni, Ti, Mo, Co, Ca, Cr, Cu, Fe, Mn, Nb, Ta, V, W, Zn, C, N, and Sn. Among these silicon-based active materials, silicon compounds are preferred, and silicon oxides are more preferred. These silicon-based active materials may be used singly or in combination of two or more.

The negative electrode active material layer is formed as a thin film on the surface of the negative electrode current collector by a vapor phase method. Examples of the vapor phase method include vacuum vapor deposition, sputtering, ion plating, laser ablation, chemical vapor deposition, plasma chemical vapor deposition, and flame spraying. Preferred among these is vacuum vapor deposition.

The negative electrode active material layer may be a solid or closely packed film including a silicon-based active material, or alternatively, an array of granular bodies or columnar bodies containing a silicon-based active material. In the latter case, it is preferable to form the negative electrode active material layer by providing a plurality of protrusions arranged regularly on the surface of the negative electrode current collector, and forming one granular body or columnar body on one protrusion. The protrusions preferably have a height of 3 μm to 20 μm, and preferably have a width of 5 μm to 20 μm. The protrusions are arranged, for example, in a staggered pattern or a grid pattern.

Further, lithium may be allowed to be absorbed into the negative electrode active material layer, in an amount equivalent to the irreversible capacity. It is preferable to allow lithium to be absorbed into the negative electrode active material layer, prior to connecting the negative electrode lead 17 to the negative electrode 10. This further improves the connection strength and the electrical conductivity between the electrode current collector of the negative electrode 10 and the negative electrode lead 17. Lithium is allowed to be absorbed into the negative electrode active material layer by, for example, vacuum vapor deposition in which vapor of lithium is supplied onto the surface of the negative electrode active material layer.

The alloy layer 20 is interposed between the negative electrode current collector of the negative electrode 10 and the negative electrode lead 17, thereby to connect the negative electrode current collector and the negative electrode lead 17 to each other as well as to provide electrical conduction therebetween. It should be noted that the alloy layer 20 is formed at one point only on one of the long sides of the negative electrode 10 in this embodiment, but this is not a limitation.

The alloy layer 20 is formed by arc-welding the portion where the negative electrode lead 17 is in contact with one of the negative electrode active material layers of the negative electrode 10. The arc welding melts the negative electrode active material layer, at least part of the negative electrode current collector being in contact with the negative electrode active material layer, and at least part of the negative electrode lead 17 being in contact with the negative electrode active material layer. This molten portion, in which the metal element(s) and the semimetal element(s) contained in the negative electrode current collector, the negative electrode active material layer, and the negative electrode lead 17 are dispersed, solidifies again, to form the alloy layer 20. The alloy layer 20 contains a silicon-copper alloy as its main component, and may possibly further contain unalloyed metal element(s) or semimetal element(s).

Next, the components of the non-aqueous electrolyte secondary battery 1 other than the negative electrode 10 and the negative electrode lead 17 are described below.

The positive electrode 11 includes a positive electrode current collector, a positive electrode active material layer formed on both surfaces of the positive electrode current collector, and a positive electrode lead 18 connected to the positive electrode current collector.

The positive electrode current collector may be any electrically conductive base material for non-aqueous electrolyte secondary batteries. The material of the conductive base material may be, for example: a metal material, such as stainless steel, titanium, aluminum, and an aluminum alloy; or a conductive resin. The conductive base material may be porous or non-porous. The porous conductive base material may be in the form of, for example, mesh, net, punched sheet, lath, porous body, foam, or nonwoven fabric. The non-porous conductive base material may be in the form of, for example, foil or film. The thickness of the conductive base material is not particularly limited, and is usually 1 μm to 500 μm, preferably 5 μm to 50 μm, and more preferably 10 μm to 30 μm.

The positive electrode active material layer contains a positive electrode active material and may further contain, for example, a conductive agent and a binder. Any material capable of absorbing and releasing lithium ions may be used without limitation as the positive electrode active material, but a lithium-containing composite oxide and an olivine type lithium phosphate are preferably used.

The lithium-containing composite oxide is a metal oxide containing lithium and a transition metal element, or alternatively a metal oxide in which part of the transition metal element in the foregoing metal oxide is replaced with another element. The transition metal element may be at least one selected from the group consisting of Sc, Y, Mn, Fe, Co, Ni, Cu, and Cr. Preferred among these are Mn, Co, and Ni. The another element may be at least one selected from the group consisting of Na, Mg, Zn, Al, Pb, Sb, and B. Preferred among these are Mg and Al.

Examples of the lithium-containing composite oxide include LiₓCoO₂, LiₓNiO₂, LiₓMnO₂, LiₓCoₘNi₁₋ₘO₂, LiₓCoₘA₁₋ₘOₙ, LiₓNi₁₋ₘAₘOₙ, LiₓMn₂O₄, and LiₓMn₂₋ₘAₙO₄, where A is at least one element selected from the group consisting of Sc, Y, Mn, Fe, Co, Ni, Cu, Cr, Na, Mg, Zn, Al, Pb, Sb, and B, 0<X1.2, m=0 to 0.9, and n=2.0 to 2.3. Preferred among these is LiₓCoₘA₁₋ₘOₙ. The lithium-containing composite oxide may possibly include an oxygen-deficient portion or an oxygen-surplus portion.

Examples of the olivine-type lithium phosphate include LiMPO₄ and LiₓMPO₄F, where M is at least one element selected from the group consisting of Co, Ni, Mn, and Fe.

In the formulae above, the value representing the molar ratio of lithium is a value upon production of the positive electrode active material and increases and decreases during charge and discharge. These positive electrode active materials may be used singly or in combination of two or more.

The conductive agent may be any conductive agent for non-aqueous electrolyte secondary batteries, examples of which include: graphites, such as natural graphite and artificial graphite; carbon blacks, such as acetylene black, Ketjen black, channel black, furnace black, lamp black, and thermal black; conductive fibers, such as carbon fiber and metal fiber; fluorinated carbon; metal powders such as aluminum; conductive whiskers, such as zinc oxide whisker; conductive metal oxides, such as titanium oxide; and organic conductive materials, such as phenylene derivative. These conductive agents may be used singly or in combination of two or more.

The binder may be any binder for non-aqueous electrolyte secondary batteries, examples of which include: resin materials, such as polyvinylidene fluoride, polytetrafluoroethylene, polyhexafluoropropylene, polyethylene, polypropylene, polyamide, polyimide, polyamide imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, and polyether sulfone; rubber materials, such as styrene-butadiene rubber and modified acrylic rubber; and water-soluble polymer compounds, such as carboxymethyl cellulose.

Alternatively, the binder may be a copolymer containing at least two monomer compounds. Examples of the monomer compound include tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene. These binders may be used singly or in combination of two or more.

The positive electrode active material layer can be formed by, for example, applying a positive electrode material mixture slurry onto a surface of the positive electrode current collector, followed by drying and rolling. The positive electrode material mixture slurry can be prepared by dissolving or dispersing the positive electrode active material and, as appropriate, the conductive agent, the binder, and the like in a dispersion medium. The dispersion medium may be, for example, dimethylformamide, dimethylacetamide, methylformamide, N-methyl-2-pyrrolidone, dimethylamine, acetone, or cyclohexanone.

One end of the positive electrode lead 18 is connected to an exposed portion of the positive electrode current collector, and the other end thereof may be connected to the sealing plate 16. These connections are achieved by welding, such as resistance welding and ultrasonic welding. The material of the positive electrode lead 18 is, for example, aluminum or an aluminum alloy. Examples of the aluminum alloy include aluminum-silicon alloy, aluminum-iron alloy, aluminum-copper alloy, aluminum-manganese alloy, aluminum-magnesium alloy, and aluminum-zinc alloy.

The separator 12 is arranged between the negative electrode 10 and the positive electrode 11. The separator 12 may be a porous sheet containing a plurality of pores and having predetermined properties such as ion permeability, mechanical strength, and insulating property. The porous sheet may be, for example, a microporous film, a woven fabric, or a nonwoven fabric. Various resin materials may be used as the material of the separator 12, but polyolefins such as polyethylene and polypropylene are preferred in view of the durability, the shutdown function, the safety of the battery, and other factors. The thickness of the separator 12 is usually 10 μm to 300 μm, and preferably 10 μm to 40 μm. The porosity of the separator 12 is preferably 30% to 70%. The porosity is a percentage of the total volume of the pores in the separator 12 to the volume of the separator 12.

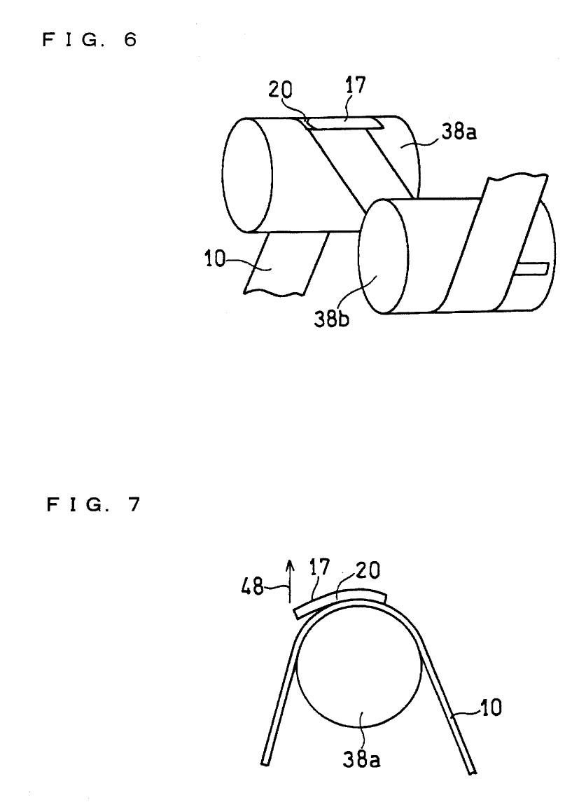

The negative electrode 10, the positive electrode 11 and the separator 12 as describe above can be used to form the electrode group 2. The electrode group 2 can be formed by, for example, an electrode group formation apparatus as shown in FIG. 5. FIG. 5 is a schematic view of an electrode group formation apparatus. FIG. 6 is an oblique view showing the negative electrode 10 with the negative electrode lead 17 connected thereto running on the surfaces of the feed rollers 38a and 38b. FIG. 7 is a side view schematically showing the negative electrode 10 with the negative electrode lead 17 connected thereto on the surface of the feed roller 38a.

As shown in FIG. 5, the negative electrode 10 fed from a negative electrode supply roller 30 is, on the way toward the feed roller 38a, combined with the negative electrode lead 17 fed from a negative electrode lead supply roller 31, and arc welding is applied thereto by a plasma welding machine 32. The negative electrode 10 with the negative electrode lead 17 connected thereto runs on the surfaces of the feed rollers 38a and 38b as shown in FIG. 6, and then is introduced into a clearance between a pair of regulation rollers 39a and 39b. In the clearance, the negative electrode 10 is laminated with the positive electrode 11 with the positive electrode lead 18 connected thereto and two separators 12, to form a laminate. This laminate is wound around a core roller 46 to form an electrode group. When the diameter of the electrode group reaches a predetermined diameter, the laminate is cut by a cutter 47. While being wound around the core roller 46, the laminate is subjected to a tension of 1 N to 100 N. The core roller 46 is then removed, leaving a hollow 2c as shown in FIG. 2 around the center of the electrode group.

In such a formation process, a problem may occur in the negative electrode 10 with the negative electrode lead 17 connected thereto, while running on the surface of the feed roller 38a, as shown in FIG. 7. Specifically, the negative electrode 10, the longitudinal direction of which coincides with the running direction, can easily follow the circular shape of the feed roller 38a. On the other hand, the negative electrode lead 17, the width direction of which coincides with the running direction, cannot follow the circular shape of the feed roller 38a, in the case where the negative electrode lead 17 and the alloy layer 20 are high in mechanical strength. As a result, part of the negative electrode lead 17 in the width direction thereof may be partially separated from the negative electrode 10 in the direction indicated by an allow 48, or the negative electrode lead 17 may be broken. However, since the negative electrode lead 17 is made of a copper foil or a copper alloy foil, and has a tensile strength within the predetermined range, the occurrence of partial separation from the negative electrode 10 or breakage of the negative electrode lead 17 can be sufficiently suppressed. Here, the diameter of the feed roller 38a is sufficiently large with respect to the width of the negative electrode lead 17, and is generally, for example, 30 to 100 mm.

The electrode group 2 thus formed is impregnated with a non-aqueous electrolyte having lithium ion conductivity. The non-aqueous electrolyte includes a lithium salt and a non-aqueous solvent, and may further include an additive.

The lithium salt may be any lithium salt for non-aqueous electrolyte secondary batteries, examples of which include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imides. These lithium salts may be used singly or in combination of two or more. The amount of the lithium salt(s) dissolved in the non-aqueous solvent is preferably 0.5 to 2 mol/L.

The non-aqueous solvent may be any non-aqueous solvent for non-aqueous electrolyte secondary batteries, examples of which include: cyclic carbonic acid esters, such as propylene carbonate and ethylene carbonate; chain carbonic acid esters, such as diethyl carbonate, ethyl methyl carbonate, and dimethyl carbonate; and cyclic carboxylic acid esters, such as γ-butyrolactone and γ-valerolactone. These non-aqueous solvents may be used singly or in combination of two or more.

Examples of the additive include: carbonate compounds that improves the charge/discharge efficiency by being decomposed on the negative electrode to form a coating with excellent lithium ion conductivity, such as vinylene carbonate, a vinylene carbonate substituted by one or two alkyl groups having one to three carbon atoms, vinylethylene carbonate, and divinylethylene carbonate; and benzene compounds that inactivates the battery by being decomposed to form a coating on the electrode surface when the battery is overcharged, such as cyclohexylbenzene, biphenyl, and diphenyl ether.

The insulating plates 13 and 14 and the gasket 19 can be produced by forming an electrically insulative material, preferably a resin material or a rubber material, into a predetermined shape. The battery case 15 and the sealing plate 16 can be produced by forming a metal material, such as iron and stainless steel, into a predetermined shape.

The non-aqueous electrolyte secondary battery 1 is a cylindrical battery including the electrode group 2, in this embodiment, but is not limited thereto and may be in various forms. For example, it may be a prismatic battery including the electrode group 2, or a prismatic battery including a flat electrode group obtained by forming the electrode group 2 into a flat shape. The flat electrode group has a cross section perpendicular to the winding axis of, for example, an approximate ellipse, or a rectangle with its both short sides being curved or arced to protrude outward. It should be noted that as long as the negative electrode lead 17 is connected to the negative electrode 10 at a predetermined position (e.g., at the long side of the rectangle of the latter shape) in the electrode group 2, if the electrode group 2 is formed into a flat shape, the negative electrode lead 17 will not be partially separated from the negative electrode 10 or broken.

### EXAMPLE

The invention is specifically described below with reference to Examples and Comparative Examples.

### Example 1

(1) Production of Positive Electrode

To an aqueous NiSO₄ solution, CoSO₄ was added such that Ni:Co=8.5:1.5 (molar ratio), to prepare an aqueous solution having a metal ion concentration of 2 mol/L. To the resultant aqueous solution, a 2 mol/L sodium hydroxide solution was gradually added dropwise, and a binary precipitate represented by Ni_{0.85}Co_{0.15}(_{OH})₂ was thus prepared by coprecipitation. The precipitate was collected by filtration, washed with water, and dried at 80° C., to give a composite hydroxide.

The resultant composite hydroxide was heated at 900° C. in air for 10 hours, to give a composite oxide represented by _{Ni}_{0.85}Co_{0.15}O₂. Subsequently, the resultant composite oxide was mixed with a monohydrate of lithium hydroxide such that the total number of Ni and Co atoms became equal to the number of Li atoms. The resultant mixture was heated at 800° C. in air for 10 hours, to give a lithium-nickel-containing composite oxide (a positive electrode active material) being represented by LiNi_{0.85}Co_{0.15}O₂ and including secondary particles with an average particle diameter of 10 μm.

Then, 93 g of the positive electrode active material powder obtained in the above was mixed with 3 g of acetylene black (conductive agent), 4 g of polyvinylidene fluoride powder (binder), and 50 mL of N-methyl-2-pyrrolidone, to prepare a positive electrode material mixture slurry. The positive electrode material mixture slurry was applied onto both surfaces of a 15-μm-thick aluminum foil (positive electrode current collector), then dried and rolled, to form a positive electrode active material layer having a thickness of 50 μm on each of both surfaces of the foil. A positive electrode plate of 56 mm×10 m in size was thus formed. On both surfaces of the positive electrode, portions (each 56 mm×width 5 mm in size) of the positive electrode active material layer were removed at intervals of 800 mm, to form positive electrode current collector-exposed portions.

(2) Positive Electrode Lead

A roll of 0.15-mm-thick aluminum foil mounted on a supply roller 34 shown in FIG. 5 was cut sequentially to give positive electrode leads each having a width of 4 mm and a length of 70 mm.

(3) Production of Negative Electrode

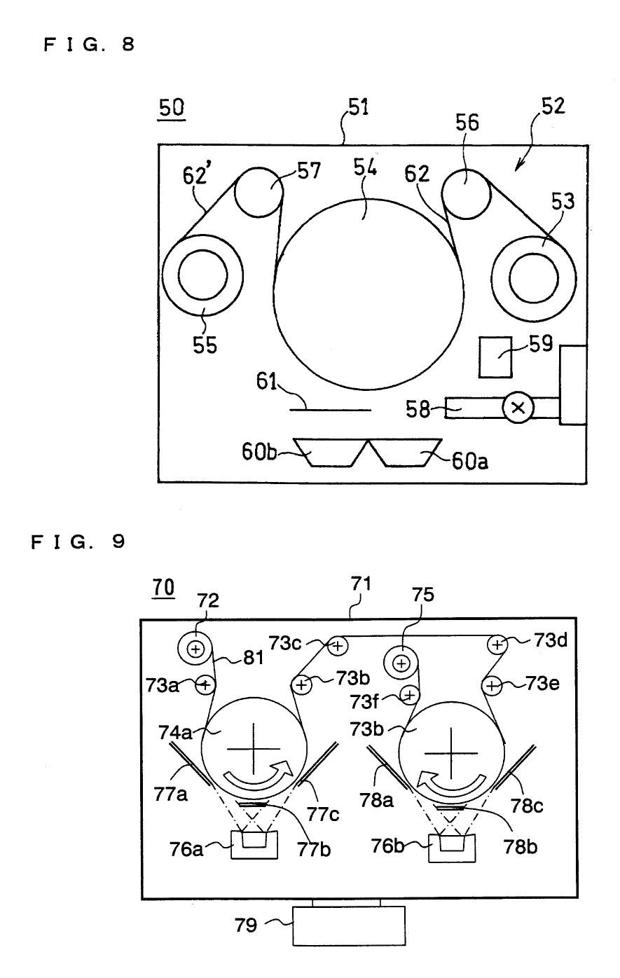

FIG. 8 is a side perspective view schematically showing the configuration of an electron beam vacuum vapor deposition apparatus 50 (hereinafter referred to as a “vapor deposition apparatus 50”). In FIG. 8, the members inside the vapor deposition apparatus 50 are shown by a solid line. The vapor deposition apparatus 50 includes a conveying means 52, a gas supply means 58, a plasma generating means 59, silicon targets 60a and 60b, a shielding plate 61, an electron beam generator (not shown), and a chamber 51 being a pressure-resistant container for accommodating these members in its interior.

The conveying means 52 includes a supply roller 53, a can 54, a take-up roller 55, and conveying rollers 56 and 57. A roll of a belt-like negative electrode current collector 62 is mounted on the supply roller 53. The can 54 is provided with a cooling means (not shown) in its interior. A negative electrode current collector 62′ with a negative electrode material layer formed on one surface thereof is taken up around the take-up roller 55.

The gas supply means 58 supplies a raw material gas such as oxygen and nitrogen into the chamber 51. When there is a supply of the raw material gas from the gas supply means 58, a negative electrode active material layer comprising an oxide or nitride of silicon is formed, and when there is no supply of the raw material gas, a negative electrode active material layer substantially consisting of silicon is formed. The plasma generating means 59 converts the raw material gas to plasma. The silicon targets 60a are 60b are used for forming a negative electrode active material layer containing silicon.

The shielding plate 61 is arranged between the can 54 and the silicon targets 60a and 60b and moves horizontally. The horizontal position of the shielding plate 61 is adjusted depending on the condition of the negative electrode active material layer formed on the surface of the negative electrode current collector 62. The electron beam generator emits electron beams toward the silicon targets 60a and 60b, to generate vapor of silicon.

According to the vapor deposition apparatus 50, the silicon vapor generated from the silicon targets 60a and 60b when irradiated with electron beams goes up toward the can 54. On the other hand, the negative electrode current collector 62 running on the surface of the can 54 is cooled by the can 54. The silicon vapor having reached the surface of the negative electrode current collector 62 is cooled, and silicon is deposited on the surface of the negative electrode current collector 62. When there is a supply of the raw material gas from the gas supply means 58, a reaction product of silicon with the raw material gas is deposited on the surface of the negative electrode current collector 62. A negative electrode active material layer is thus formed.

A negative electrode active material layer (a thin film or solid film of silicon) having a thickness of 5 μm was formed on each of both surfaces of the negative electrode current collector 62 by using the vapor deposition apparatus 50, under the following conditions, to form a negative electrode plate.

Pressure in chamber 51: 8.0×10⁻⁵ Torr

Negative electrode current collector 62: an electrolytic copper foil with roughened surface (available from Furukawa Electric Co., Ltd., thickness: 35 μm, width: 59 mm, and length: 10 m)

Take-up speed of negative electrode current collector 62 by take-up roller 55 (conveying speed of the negative electrode current collector 62): 2 cm/min

Raw material gas: not supplied

Targets 60a and 60b: monocrystalline silicon with 99.9999% purity, available from Shin-Etsu Chemical Co., Ltd.

Accelerating voltage of electron beams: −8 kV

Emission of electron beams: 300 mA

Lithium metal was vapor-deposited on the surface of the negative electrode active material layer of the obtained negative electrode plate. By vapor-depositing lithium metal, lithium was supplemented to the negative electrode active material layer in an amount equivalent to the irreversible capacity to be stored during initial charge and discharge of the battery. The vapor deposition of lithium metal was performed in an argon atmosphere using a resistance heating vapor deposition apparatus (available from ULVAC, Inc.). Specifically, lithium metal was placed on the tantalum boat in the resistance heating vapor deposition apparatus, and the negative electrode plate was fixed such that the negative electrode active material layer faced the tantalum boat. The vapor deposition was carried out for 10 minutes in an argon atmosphere, while a current of 50 A was being allowed to flow through the tantalum boat.

(4) Negative Electrode Lead

A roll of tough pitch copper foil (trade name: TPC, thickness: 0.1 mm, available from Hitachi Cable, Ltd.) mounted on the supply roller 31 in the electrode group formation apparatus shown in FIG. 5 was cut sequentially to give negative electrode leads each having a length of 80 mm and a width of 3 mm. The maximum tensile strength of each negative electrode lead pulled in the longitudinal direction was 120 N. Since the width of the negative electrode lead was 3 mm, the tensile strength of the negative electrode lead per 1 mm of the short side width thereof was 40 N/mm.

(5) Separator

A polyethylene microporous film (Trade name: Hipore, thickness: 20 μm, available from Asahi Kasei E-materials Corporation) was used as the separator. The separator was 62 mm in width and 10 m in length.

(6) Formation of Electrode Group

The negative electrode plate, the negative electrode leads, the positive electrode plate, the positive electrode leads, and the separator obtained in the above were used as the negative electrode 10, the negative electrode lead 17, the positive electrode 11, the positive electrode lead 18, and the separator 12, respectively. Specifically, rolls of the negative electrode plate, positive electrode plate, and separators were mounted on the predetermined supply rollers 30, 33, 36 and 37 in the electrode group formation apparatus shown in FIG. 5. The negative electrode lead 17 was fed from the negative electrode lead supply roller 31 to the negative electrode 10 held in a tensioned state between the negative electrode supply roller 30 and the feed roller 38a. The positive electrode lead 18 was fed from the positive electrode lead supply roller 34 to the current collector-exposed portion of the positive electrode 11 fed from the positive electrode supply roller 33.

In supplying the lead, the negative electrode lead 17 was placed on the negative electrode 10 at a position to be 900 mm away from the winding-axis side end of the negative electrode 10 in the longitudinal direction thereof, such that the longitudinal directions of the negative electrode 10 and the negative electrode lead 17 orthogonally crossed each other, and the widthwise end of the negative electrode lead 17 protruded by 0.1 mm from the long side of the negative electrode 10. In this state, the negative electrode 10 and the negative electrode lead 17 were fixed by a uniaxial robot 49a (a clamping jig, available from IAI Co., Ltd.). In the similar manner, the positive electrode 11 and the positive electrode lead 18 were fixed at the current collector-exposed portion of the positive electrode by a uniaxial robot 49b.

Next, plasma welding was performed by using a plasma welding machine (trade name: PW-50NR, available from Koike Sanso Kogyo Co., Ltd.) 32 such that the adjacent end surfaces of the negative electrode 10 and the negative electrode lead 17 were irradiated with energy in the direction perpendicular thereto under the following conditions, thereby to form the alloy layer 20. The negative electrode 10 and the negative electrode lead 17 were thus connected to each other as shown in FIG. 3. In the similar manner, the negative electrode lead 17 was connected to the negative electrode 10 at a position to be 900 mm away from the winding-axis side end of the negative electrode 10 in the longitudinal direction thereof. On the other hand, the positive electrode lead 18 was welded to the positive electrode 11 by a predetermined method using a predetermined welding machine 35.

<Conditions for plasma welding>

Electrode rod: 1.0 mm in diameter

Electrode nozzle: 1.6 mm in diameter

Distance between torch and workpiece: 2.0 mm

Sweeping speed of torch: 30 mm/s

Plasma gas: argon

Plasma gas flow rate: 100 sccm

Shielding gas: hydrogen, argon

Shielding gas flow rate (hydrogen): 500 sccm

Shielding gas flow rate (argon): 1 slm

Welding current: 8.0 A

The negative electrode 10 with the negative electrode lead 17 connected thereto was allowed to run on the surfaces of the feed rollers 38a and 38b (each being an iron roller of 60 mm in diameter) at a running speed of 30 mm/sec. While the negative electrode was running on the surface of the feed roller 38a, the negative electrode lead 17 was not partially separated from the negative electrode 10 or broken.

Subsequently, the negative electrode 10 with the negative electrode lead 17 connected thereto, the separator 12, the positive electrode 11 with the positive electrode lead 18 connected thereto at the current collector-exposed portion, and the separator 12 were laminated in this order between the regulation rollers 39a and 39b, to give a laminate. The laminate was taken up around the core roller 46, while a tension of 10 N is applied to the laminate. When the diameter of the wound laminate reached a predetermined diameter, the laminate was cut by the cutter 47. In such a manner, a wound electrode group having an approximate circular cross section and a diameter of 16 mm, in which the negative electrode lead 17 was connected at the round of winding radially 8 mm away from its center, and the positive electrode lead 18 was connected at the round of winding radially 11 mm away from its center was produced. The negative electrode lead 17 and the positive electrode lead 18 were arranged such that they protrude from both ends of the electrode group in opposite directions along the winding axis of the wound electrode group.

(7) Production of Battery

An insulating plate made of polyethylene was disposed on both end surfaces of the wound electrode group. The other end of the positive electrode lead was welded to the sealing plate, and the other end of the negative electrode lead was welded to the bottom inner surface of a bottomed cylindrical battery case made of iron. Next, the wound electrode group was inserted in the battery case, and a non-aqueous electrolyte was injected into the battery case.

The non-aqueous electrolyte had been prepared by dissolving LiPF₆ at a concentration of 1.0 mol/L in a mixed solvent containing ethylene carbonate and ethyl methyl carbonate in a ratio of 1:1 by volume. A sealing plate was disposed inside the opening end of the battery case, with a polyethylene gasket interposed therebetween, and the opening end of the battery case was crimped inwardly to seal the battery case. A cylindrical non-aqueous electrolyte secondary battery was thus produced.

### Example 2

A cylindrical non-aqueous electrolyte secondary battery was produced in the same manner as in Example 1, except that the below-described negative electrode lead was used.

A tough pitch copper foil (trade name: TPC, thickness: 0.15 mm, available from Hitachi Cable, Ltd.) was annealed at 200° C. for 1 hour in an argon atmosphere. A negative electrode lead having a length of 80 mm and a width of 3 mm was cut out of the resultant annealed tough pitch copper foil. The maximum tensile strength of the negative electrode lead was 90 N. Since the width of the negative electrode lead was 3 mm, the tensile strength of the negative electrode lead per 1 mm of the short side width thereof was 30 N/mm.

### Example 3

A cylindrical non-aqueous electrolyte secondary battery was produced in the same manner as in Example 1, except that the below-described negative electrode lead was used.

A negative electrode lead having a length of 80 mm and a width of 3 mm was cut out of a zirconium-copper alloy foil (trade name: HCL-02Z, thickness: 0.05 mm, available from Hitachi Cable, Ltd.). The maximum tensile strength of the negative electrode lead was 66 N. Since the width of the negative electrode lead was 3 mm, the tensile strength of the negative electrode lead per 1 mm of the short side width thereof was 22 N/mm.

### Example 4

A cylindrical non-aqueous electrolyte secondary battery was produced in the same manner as in Example 1, except that the below-described negative electrode lead was used.

A negative electrode lead having a length of 80 mm and a width of 3 mm was cut out of a Corson alloy foil (trade name: HCL-305, thickness: 0.05 mm, available from Hitachi Cable, Ltd.). The maximum tensile strength of the negative electrode lead was 111 N. Since the width of the negative electrode lead was 3 mm, the tensile strength of the negative electrode lead per 1 mm of the short side width thereof was 37 N/mm.

### Example 5

A cylindrical non-aqueous electrolyte secondary battery was produced in the same manner as in Example 1, except that the width of the negative electrode lead was changed from 3 mm to 3.5 mm. The maximum tensile strength of the negative electrode lead was 140 N, and accordingly, the tensile strength of the negative electrode lead per 1 mm of the short side width thereof was 40 N/mm.

### Example 6

A cylindrical non-aqueous electrolyte secondary battery was produced in the same manner as in Example 1, except that the below-described negative electrode was used.

(1) Production of Negative Electrode

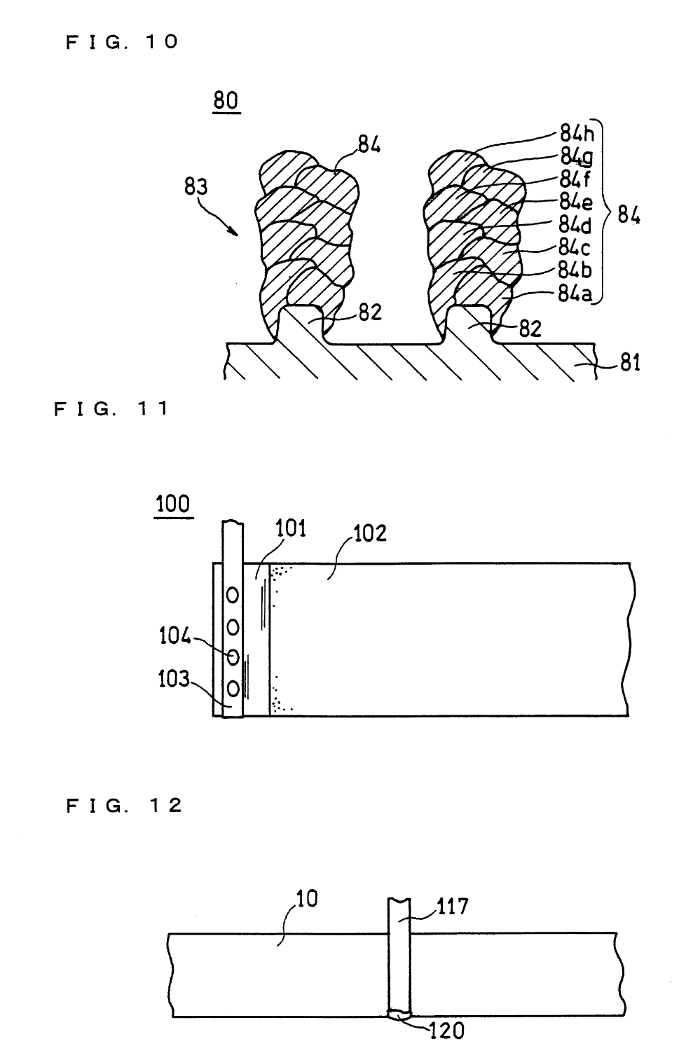

FIG. 9 is a side perspective view schematically showing the configuration of an electron beam vacuum vapor deposition apparatus 70 (hereinafter referred to as a “vapor deposition apparatus 70”). FIG. 10 is a vertical cross-sectional view schematically showing the configuration of a negative electrode 80 to be produced in this Example.

A plurality of recesses were formed by laser machining on the surface of a forged steel roller (available from DAIDO MACHINERY, LTD., diameter: 50 mm, roll width: 100 mm). The recesses were arranged in a predetermined pattern in which the axis-to-axis distance between a pair of adjacent recesses was 20 μm. The opening of each recess had a shape of an approximate rhombus having a long diagonal of 19.5 μm and a short diagonal of 9.8 μm. The depth of the recess was 8 μm, and the bottom of the recess was almost flat at its center and was rounded at the portion where the periphery of the bottom meets the side of the recess. In such a manner, a roller for forming protrusions was prepared. Two rollers for forming protrusions were press-fitted at a line pressure of 1 t/cm, with the axes of the rollers aligned in parallel to each other, to form a press-fit nip portion.

On the other hand, a copper alloy foil containing 0.03% by mass of zirconium (trade name: HCL-02Z, thickness: 20 μm, available from Hitachi Cable, Ltd.) was heated at 600° C. for 30 minutes in an argon gas atmosphere, to be annealed. The annealed copper alloy foil was allowed to pass through the press-fit nip portion and thereby molded under pressure. A negative electrode current collector 81 as shown in FIG. 10 was thus obtained. The average height of protrusions 82 was about 8 μm. The protrusions 82 each had a shape of an approximate rhombus. The protrusions 82 were arranged on the surfaces of the negative electrode current collector 81. It should be noted that FIG. 10 shows only one surface of the negative electrode current collector 81, but both surfaces of the negative electrode current collector 81 have the protrusions 82.

Next, columnar bodies 84 were formed using the vapor deposition apparatus 70 such that one columnar body 84 was formed on the surface of each protrusion 82 of the negative electrode current collector 81 obtained in the above, whereby the negative electrode 80 was produced.

The vapor deposition apparatus 70 is equipped with: a supply roller 72 for mounting a roll of the negative electrode current collector 81 thereon; conveying rollers 73a, 73b, 73c, 73d, 73e, and 73f; vapor deposition sources 76a and 76b; a take-up roller 75 for taking up the negative electrode current collector 81 with a silicon-based active material layer formed on the surface of each protrusion 82; a pair of shielding plates 77 and 78 for regulating the region where the vapor of a silicon-based active material is to be supplied; oxygen nozzles (not shown) for supplying oxygen; an electron beam generator (not shown); a chamber 71 for accommodating these; and a vacuum pump 79 for evacuating the chamber 71. The shielding plate 77 comprises shielding strips 77a, 77b, and 77c. The shielding plate 78 comprises shielding strips 78a, 78b, and 78c.

In the vapor deposition apparatus 70, in the direction along which the negative electrode current collector 81 is conveyed, a first vapor-deposition region is provided between the shielding strips 77a and 77b, a second vapor-deposition region is provided between the shielding strips 77b and 77c, a third vapor-deposition region is provided between the shielding strips 78c and 78b, and a fourth vapor-deposition region is provided between the shielding strips 78b and 78a.

The material of the silicon-based active material used here was a scrap silicon (monocrystalline silicon, purity: 99.9999%, available from Shin-Etsu Chemical Co., Ltd.), which was placed in the vapor deposition sources 76a and 76b. The chamber 71 was evacuated by the vacuum pump 79 to a pressure of 5×10⁻³ Pa, and thereafter, oxygen was supplied into the camber 71 at a rate of 50 sccm from each oxygen nozzle (not shown) respectively disposed at the first to fourth vapor-deposition regions. Subsequently, electron beams (accelerating voltage: 10 kV, emission: 500 mA) was radiated to the vapor deposition sources 76a and 76b, to generate the vapor of silicon.

The negative electrode current collector 81 was fed from the supply roller 72 at a rate of 2 cm/min. While the negative electrode current collector 81 was passing through the first vapor-deposition region, a mixture of silicon vapor and oxygen was vapor-deposited on each protrusion 82, forming a mass 84a as shown in FIG. 10. Next, a mass 84b was formed on the protrusion 82 and the mass 84a, while the negative electrode current collector 81 was passing through the second vapor-deposition region. Further, in the third and fourth vapor-deposition regions, the masses 84a and 84b were formed on each protrusion 82 on the other surface of the negative electrode current collector 81 opposite to the surface on which the masses 84a and 84b have been formed in the first and second vapor-deposition regions.

Next, the supply roller 72 and the take-up roller 75 were rotated in the reverse direction, to convey the negative electrode current collector 81 in the reverse direction, so that masses 84c and 84d were formed on the masses 84a and 84b on both surfaces of the negative electrode current collector 81. This vapor deposition in forward and reverse directions was performed again in the same manner, to form columnar bodies 84 each comprising the masses 84a, 84b, 84c, 84d, 84e, 84f, 84g, and 84h on the protrusions 82 on both surfaces of the negative electrode current collector 81. The negative electrode 80 was thus obtained.

The columnar bodies 84 were supported on the surfaces of the protrusions 82, and have grown outwardly from the negative electrode current collector 81. The three-dimensional shape of each columnar body 84 was approximately cylindrical. The columnar bodies 84 had an average height of 20 μm and an average width of 40 μm. The content of oxygen in the columnar bodies 84 was determined by a combustion method, and the result found that the composition of the columnar bodies 84 was SiO_{0.25}.

To a negative electrode active material layer 83 comprising a plurality of the columnar bodies 84 in the negative electrode 80 obtained in the above, lithium was supplemented in an amount equivalent to the irreversible capacity, by using a resistance heating vapor deposition apparatus. The vapor deposition apparatus is equipped with: a supply roller for mounting a roll of the belt-like negative electrode 80 thereon; a can provided with a cooler in its interior; a take-up roller for taking up the negative electrode 80 with silicon supplemented thereto; a conveyor roller for conveying the negative electrode 80; a tantalum boat for accommodating metal lithium; a shielding plate for limiting the supply of vapor of lithium to the surface of the negative electrode 80; and a pressure-resistant container for accommodating these.

First, the atmosphere in the chamber of the vapor deposition apparatus was replaced with an argon atmosphere, and the chamber was evacuated by a vacuum pump (not shown) to a degree of vacuum of 1×10⁻¹ Pa. Next, a current of 50 A was allowed to pass through the boat, to generate vapor of lithium, and the negative electrode 80 was fed from the supply roller at a rate of 2 cm/min, to allow lithium to be deposited in an amount equivalent to the irreversible capacity, on the surface of the negative electrode active material layer in the negative electrode 80, while the negative electrode 80 was running on the surface of the can. Lithium was vapor-deposited on both of the negative electrode active material layers 83 in the negative electrode 80. In such a manner, the negative electrode 80 supplemented with lithium was produced.

### Comparative Example 1

A cylindrical non-aqueous electrolyte secondary battery was produced in the same manner as in Example 1, except that the below-described negative electrode lead was used.

A negative electrode lead having a length of 80 mm and a width of 3 mm was cut out of a tough pitch copper foil (trade name: TPC, thickness: 0.15 mm, available from Hitachi Cable, Ltd.). The maximum tensile strength of the negative electrode lead was 180 N. Since the width of the negative electrode lead was 3 mm, the tensile strength of the negative electrode lead per 1 mm of the short side width thereof was 60 N/mm.

### Comparative Example 2

A cylindrical non-aqueous electrolyte secondary battery was produced in the same manner as in Example 1, except that the below-described negative electrode lead was used.

A negative electrode lead having a length of 80 mm and a width of 3 mm was cut out of a zirconium-copper alloy foil (trade name: HCL-02Z, thickness: 0.13 mm, available from Hitachi Cable, Ltd.). The maximum tensile strength of the negative electrode lead was 175.5 N. Since the width of the negative electrode lead was 3 mm, the tensile strength of the negative electrode lead per 1 mm of the short side width thereof was 58.5 N/mm.

### Comparative Example 3

A cylindrical non-aqueous electrolyte secondary battery was produced in the same manner as in Example 1, except that the below-described negative electrode lead was used.

A negative electrode lead having a length of 80 mm and a width of 3 mm was cut out of a Corson alloy foil (trade name: HCL-305, thickness: 0.1 mm, available from Hitachi Cable, Ltd.). The maximum tensile strength of the negative electrode lead was 225 N. Since the width of the negative electrode lead was 3 mm, the tensile strength of the negative electrode lead per 1 mm of the short side width thereof was 75 N/mm.

### Example 7

A wound electrode group was formed in the same manner as in Example 1, except that the negative electrode lead was connected to the end portion of the negative electrode near the winding axis in the longitudinal direction thereof. The wound electrode group thus formed had a diameter of 16 mm, in which the negative electrode lead was connected to the innermost round of winding radially 1.5 mm away from the center of the electrode group. A cylindrical non-aqueous electrolyte secondary battery was produced in the same manner as in Example 1, except that the wound electrode group thus formed was used.

### EVALUATION

The batteries of Examples 1 to 7 and Comparative Examples 1 to 3 were evaluated for the following items.

### [Partial Separation From Negative Electrode and Breakage of Lead]

One hundred batteries each were produced for Examples 1 to 7 and Comparative Examples 1 to 3, in order to determine visually whether partial separation from the negative electrode and/or breakage of the negative electrode lead had occurred or not in the process of producing these batteries.

First, whether partial separation from the negative electrode and/or breakage of the negative electrode lead had occurred or not while the negative electrode with the negative electrode lead connected thereto was running on the surface of the feed roller was determined. The number of the negative electrodes in which neither partial separation nor breakage of the negative electrode lead had occurred was counted, and the percentage (%) of this number to the total number produced (100) was calculated. The results are shown in Table 1.

Next, the negative electrode with the negative electrode lead connected thereto, the separator, the positive electrode with the positive electrode lead connected thereto, and the separator were laminated and wound together, and upon completion of winding, the resultant wound electrode group was unwound, to determine whether partial separation from the negative electrode and/or breakage of the negative electrode lead had occurred or not during winding. The number of the negative electrodes in which neither partial separation nor breakage of the negative electrode lead had occurred was counted, and the percentage (%) of this number to the total number produced (100) was calculated. The results are shown in Table 1. Here, the battery in which partial separation from the negative electrode and/or breakage of the negative electrode lead had occurred during running on the surface of the feed roller was not subjected to this evaluation.

Further, ten batteries each were produced for Examples 1 to 7 and Comparative Examples 1 to 3, and then subjected to 100 cycles of charge and discharge (at 25° C.) under the conditions (a) to (d) below. Thereafter, the batteries were disassembled, to determine whether partial separation from the negative electrode and/or breakage of the negative electrode lead had occurred or not. The number of the negative electrodes in which neither partial separation nor breakage of the negative electrode lead had occurred was counted, and the percentage (%) of this number to the total number produced (10) was calculated. The results are shown in Table 1.

(a) Constant-current charge: current value 1 C, charge cut-off voltage 4.2 V.

(b) Constant-voltage charge: voltage value 4.2 V, charge cut-off current 0.05 C.

(c) Interval between charge and discharge: 20 minutes

(d) Constant-current discharge: current value 1 C, discharge cut-off voltage 2.5 V.

### [Cycle Characteristics]

The batteries of Examples 1 to 7 and Comparative Examples 1 to 3 were subjected to 100 cycles of charge and discharge (at 25° C.) under the conditions (a) to (d) above. The percentage of the total discharge capacity at the 100th cycle to that at the 1st cycle was determined as a capacity retention rate (%). The results are shown in Table 1.

With regard to the capacity retention rates of Comparative Examples 1 to 3, the batteries in which the negative electrode lead had not broken during 100 cycles of charge and discharge exhibited a comparatively high capacity retention rate of 89 to 90%, whereas the capacity retention rates of the batteries in which the negative electrode lead had broken were 0%.

TABLE 1

| | Partial separation from negative | | | |
|---|---|---|---|---|
| | electrode and breakage of lead | | | |
| | During | | | |
| | running on | | After | Capacity |
| | surface of | During | charge/ | retention |
| | feed roller | winding | discharge | rate |
| | (%) | (%) | (%) | (%) |
| Ex. 1 | 100 | 100 | 100 | 89 |
| Ex. 2 | 100 | 100 | 100 | 90 |
| Ex. 3 | 100 | 100 | 100 | 90 |
| Ex. 4 | 100 | 100 | 100 | 90 |
| Ex. 5 | 98 | 95 | 90 | 89 |
| Ex. 6 | 100 | 100 | 100 | 93 |
| Com. Ex. 1 | 87 | 70 | 50 | 89 or 0 |
| Com. Ex. 2 | 85 | 71 | 50 | 89 or 0 |
| Com. Ex. 3 | 56 | 31 | 20 | 90 or 0 |
| Ex. 7 | 100 | 73 | 60 | 90 or 0 |

It is clear from Table 1 that the batteries of Examples 1 to 6, in which there was almost no occurrence of partial separation from the negative electrode and breakage of the negative electrode lead in the process of producing these batteries, can be produced with fewer defects even when produced in industrial scale. Particularly, with regard to the batteries of Examples 1 to 4 and 6, the effect to prevent the partial separation from the negative electrode and breakage of the negative electrode lead is evident. It is also clear that the batteries of Example 1 to 6 are excellent in battery performance such as cycle characteristics.

In contrast, in the batteries of Comparative Examples 1 to 3, the occurrence of the partial separation from the negative electrode and breakage of the negative electrode lead was increased, presumably because the tensile strength per 1 mm of the short side width of the negative electrode lead was beyond the range specified by the invention. Particularly, in the battery of Comparative Example 3, the tensile strength per 1 mm of the short side width of the negative electrode lead was very high, and, presumably because of this, the occurrence of the partial separation from the negative electrode and breakage of the negative electrode lead was high in all occasions: during running on the surface of the feed roller, during winding, and after charge/discharge. With regard to the battery of Example 7, since the negative electrode lead was connected at a position within 3 mm in radius from the center of the electrode group, the negative electrode lead was not partially separated or broken during running on the surfaces of the feed roller; however, the occurrence of the partial separation from the negative electrode and breakage of the negative electrode lead during wining was comparatively increased. Nevertheless, the results of Example 7 were favorable as compared to those of Comparative Examples 1 to 3. It should be noted that in producing a battery other than the cylindrical battery, such as a prismatic battery, the occurrence of the partial separation from the negative electrode and breakage of the negative electrode lead during winding can be suppressed irrespective of the distance of the connection point of the negative electrode lead from the center (winding axis) of the electrode group.

The non-aqueous electrolyte secondary battery of the invention can be used for the same application as those for the conventional non-aqueous electrolyte secondary batteries, and is particularly useful as a main power source or an auxiliary power source for, for example, electronic equipment, electric equipment, machining equipment, transportation equipment, and power storage equipment. Examples of the electronic equipment include personal computers, cellular phones, mobile devices, personal digital assistants, and portable game machines. Examples of the electric equipment include vacuum cleaners and video cameras. Examples of the machining equipment include electric powered tools and robots. Examples of the transportation equipment include electric vehicles, hybrid electric vehicles, plug-in hybrid electric vehicles, and fuel cell-powered vehicles. Examples of the power storage equipment include uninterrupted power supplies.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A non-aqueous electrolyte secondary battery comprising: a wound electrode group including a belt-like positive electrode, a belt-like negative electrode, and a belt-like separator interposed between the positive electrode and the negative electrode, the positive electrode, the negative electrode, and the separator being laminated and wound together; and a non-aqueous electrolyte,
the negative electrode comprising a current collector, an active material layer including a silicon-based active material and adhering to a surface of the current collector, a strip-like lead connected to the current collector via an alloy layer comprising a copper-silicon alloy, and
the lead including a copper foil or a copper alloy foil having a tensile strength per unit length of a short side width thereof of 3 N/mm to 50 N/mm.

2. The non-aqueous electrolyte secondary battery in accordance with claim 1, wherein the short side width of the lead is 3 mm or less.

3. The non-aqueous electrolyte secondary battery in accordance with claim 1, wherein the copper foil is a tough pitch copper foil, the tough pitch copper foil being an annealed tough pitch copper foil having a thickness of 0.05 mm to 0.33 mm.

4. The non-aqueous electrolyte secondary battery in accordance with claim 1, wherein the copper foil is a tough pitch copper foil, the tough pitch copper foil being an unannealed tough pitch copper foil having a thickness of 0.12 mm or less.

5. The non-aqueous electrolyte secondary battery in accordance with claim 1, wherein the copper alloy foil is a zirconium-copper alloy foil having a thickness of 0.1 mm or less.

6. The non-aqueous electrolyte secondary battery in accordance with claim 1, wherein the copper alloy foil is a Corson alloy foil having a thickness of 0.06 mm or less.

7. The non-aqueous electrolyte secondary battery in accordance with claim 1, wherein the lead is connected to the current collector by a plasma welding.

8. The non-aqueous electrolyte secondary battery in accordance with claim 1, wherein
the current collector has a plurality of protrusions on a surface thereof, and
the active material layer includes a plurality of granular bodies each supported on a surface of each of the plurality of protrusions,
the plurality of granular bodies each including the silicon-based active material.

9. The non-aqueous electrolyte secondary battery in accordance with claim 1, wherein
the electrode group has a cylindrical shape,
a cross section perpendicular to a winding axis of the electrode group has a radius of 3 mm or more, and
the lead is connected at a round of winding radially 3 mm or more away from the winding axis of the electrode group.
